(19) United States
(12) Patent Application Publication
(10) Pub. No.: US 2012/0183381 A1
(43) Pub. Date: Jul. 19, 2012

(54) Cargo Lift System

(76) Inventor: William Gordon, Buffalo, MO (US)

(21) Appl. No.: 13/352,845

(22) Filed: Jan. 18, 2012

Related U.S. Application Data
(60) Provisional application No. 61/461,412, filed on Jan. 18, 2011.

(51) Int. Cl. B60P 1/44

(52) U.S. Cl. 414/540; 414/812

(57) ABSTRACT

A cargo lift system for loading cargo at or near ground level and raising it over a vehicle is described. The cargo lift system may be attached to a variety of vehicles, including but not limited to horse trailers, recreational vehicles, cars and trucks and other vehicles. The cargo lift system can be used to securely transport a wide variety of cargo over a vehicle and safely loading and unloading the cargo from the vehicle.

### CROSS-REFERENCE TO RELATED APPLICATIONS

This non-provisional application claims priority of U.S. Provisional Patent Application No. 61/461,412 filed on Jan. 18, 2011, which application is incorporated herein by reference.

### BACKGROUND

### Field of the Invention

The cargo lift system described herein relates to equipment for lifting cargo and securing it above or on the roof of trailers, cars, recreational vehicles, and other types of vehicles. More specifically, the cargo lift system relates to systems for raising and lowering cargo such as cargo boxes, supply pods, hay pods, cargo racks, and other items from at or near ground level to at or above the'roof of various types of vehicles, and securing them there for transport.

### SUMMARY OF THE INVENTION

A cargo lift system for a vehicle is described, comprising a lift tower, a trolley slidably secured in the lift tower for translating from the top to the bottom of the lift tower, a lift platform rotatably attached to the trolley, and a lift mechanism disposed in the lift tower and capable of raising and lowering the trolley in the lift tower, wherein the lift platform may be rotated around the trolley from one side of the lift tower to the other.

In some embodiments the cargo lift system further comprises a swivel mechanism attached to the lift platform for rotating the lift platform around the lift tower. Other embodiments of the cargo lift system may be attached to the side of a vehicle by one or more lift towers.

A method of transporting cargo on a vehicle is also described, comprising the steps of providing a cargo lift system comprising a lift tower, a trolley slidably disposed in the lift tower for translating from the top to the bottom thereof, a lift platform rotatably attached to the trolley, a lift mechanism disposed in the lift tower and capable of raising and lowering the trolley in the lift tower; attaching the lift tower to the vehicle; positioning the lift platform in a lowered position at or near a lower end of the lift tower and rotated away from the vehicle; securing the cargo on the lift platform; engaging the lift mechanism to raise the lift platform to at or near an upper end of the lift tower; rotating the lift platform around the lift tower and above the vehicle.

In other embodiments of the method the step of providing a cargo system further comprises providing a swivel mechanism for rotating the lift platform around the lift tower.

### BRIEF DESCRIPTION OF THE DRAWINGS

FIG. 1 is a perspective view of an embodiment of the cargo lift system in a raised position.

FIG. 2 is a perspective view of an embodiment of the cargo lift system in a lowered position.

FIG. 3 is a detailed view of an embodiment of the swivel mechanism of the cargo lift system.

FIG. 4 is a perspective view of an alternative embodiment of the cargo lift system in a raised position.

FIG. 5 is a detailed view of an alternative embodiment of the cargo lift system.

FIG. 6 is a partial schematic view of an embodiment of a control system for the cargo lift system.

FIG. 7 is a partial schematic view of an embodiment of a control system for the cargo lift system.

### DETAILED DESCRIPTION

The cargo lift system as disclosed in reference to the embodiment depicted in the figures provides a system for lifting cargo from at or near ground level to at or above the level of the roof of a vehicle such as a trailer, automobile, truck, recreational vehicle or other vehicle. The cargo list system allows a user to easily load cargo onto a cargo rack at ground level, and lift the cargo above the vehicle where it is secured for transport along with the vehicle.

The cargo lift system allows users who may be unable to reach the top of their vehicle or who do not have the strength to lift cargo onto the vehicle, to easily load and position the cargo on a lift platform at or near ground level. Once the cargo is arranged and secured to the lift platform, the user engages a manual or powered lift mechanism to raise the lift platform above the vehicle and swivel it so that it is positioned above the vehicle or the vehicle roof. This system may be used, by way of example and without limitation, to load and transport hay above a horse trailer, or camping gear above a recreational vehicle, among many other alternatives.

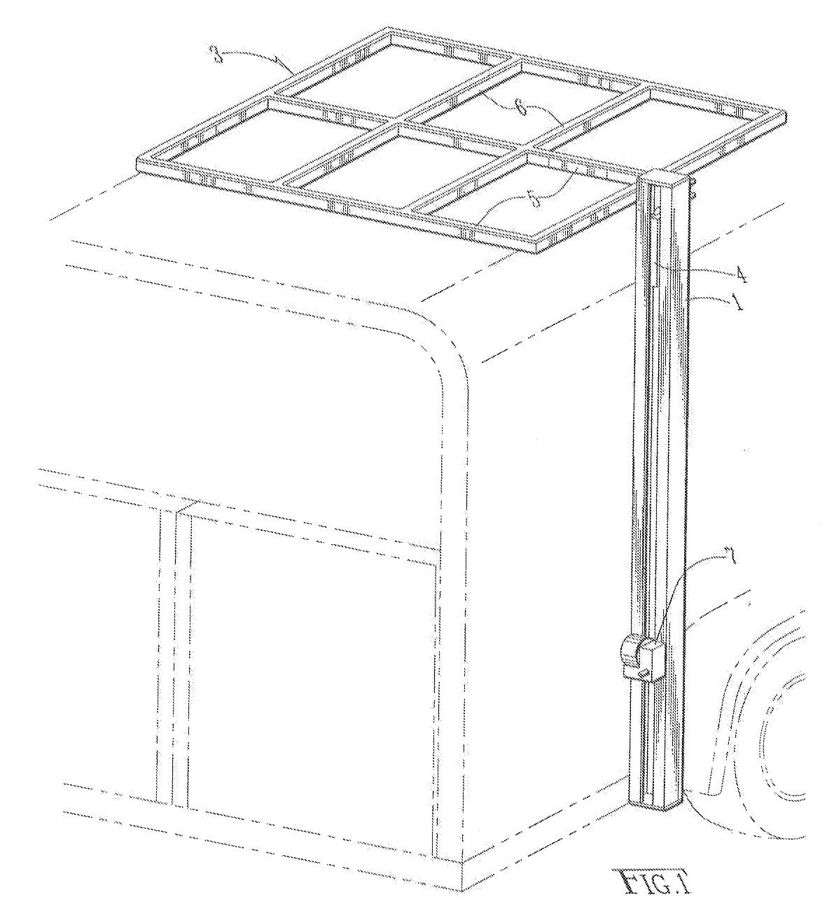

Referring now to FIG. 1, a perspective view of an embodiment of the cargo lift system is depicted with the cargo platform in a raised position. A lift tower 1 is provided for attachment to the vehicle with which the cargo lift system will be utilized. The tower 1 is securely attached to the vehicle to support the weight of the cargo lift system and the cargo loaded on the lift platform. In some embodiments and depending on the type and strength of the vehicle to which the cargo lift system is to be attached, the lift tower 1 may comprise two vertical components for attaching to each side of the vehicle and a horizontal component for bridging above the vehicle between the two vertical components. The lift tower may be formed from cylinders or square columns of sheet metal, metal channel, or other sufficiently strong and rigid materials and structures to attach firmly to the vehicle and support the weight of the cargo lift system and the cargo loaded thereon. In the depicted embodiment, the lift tower 1 comprises a single tower attached to one side of the vehicle. In some embodiments, the lift tower 1 may be welded, bolted or screwed to the side of the vehicle, and in other embodiments the lift tower may be mounted on a received hitch on the vehicle.

The lift tower 1 is provided with trolley guide rails 2 for guiding the lift platform 3 up and down the lift tower 1. A trolley 4 is maintained by rails 2 within tower 1 and can translate vertically up and down tower 1. A lift mechanism 7 is provided in lift tower 1 to raise and lower the trolley 4 within the lift tower 1. The lift mechanism 7 may comprise a cable and crank system, a screw-based linear translator, a chain winch, hydraulic components, or any other type of system capable of raising and lowering the trolley 4 in the list tower 1 and supporting it at any point along the height of the lift tower 1 as necessary. The lift platform 3 is attached to trolley 4 and is raised and lowered by trolley 4. An embodiment of the trolley 4 will be described in reference to a later figure.

The lift platform 3 may be of any form susceptible for securing cargo to the lift platform 3. In the embodiment shown in the figures, the lift platform 3 is made up of a plurality of rails 5 and 6 formed into a platform for holding cargo. The lift platform 3 may further comprise a sheet, mesh or other material affixed to the rails forming a floor for the platform, or further comprise raised side rails set around and above the level of rails 5 and 6.

The lift platform 3 is secured to the trolley 4 by a swivel mechanism that allows the cargo lift platform 3 to swivel around the lift tower 1 when lifted to the top of the lift tower 1. In the lowered position, the lift platform 3 is disposed on the side of the lift tower 1 away from the vehicle to which the system is attached and is at or near to ground level.

The lift platform 3 is raised to near or at the top of the lift tower 1 by means described with reference to a later figure, and then the lift platform 3 is swiveled around the lift tower so that the lift platform 3 is positioned above the vehicle. The lift platform 3 then may be lowered onto the roof of the vehicle or held slightly above the vehicle by lift tower 1 for movement of the vehicle and the cargo loaded onto the vehicle as a unit. In some embodiments of the system a fitted cradle may be provided for attachment to the roof of the vehicle. In other embodiments, the platform may rest on a cargo rack provided with the vehicle or rest on the roof of the vehicle directly.

The lift platform 3 may be swiveled around the lift tower 1 manually or by a powered system, not depicted in the figures, such as an electric or hydraulic actuator, motor or crank. In embodiments, the actuator may be connected between the lift platform and the trolley 4 to rotate the lift platform 3 around the trolley 4 when it is actuated. In an embodiment, a gear, sprocket or pulley is fixed to the trolley 4 and an electric, pneumatic, hydraulic or similar motor mounted on the lift platform 3 is connected to the gear, sprocket or pulley by a chain or belt, causes the lift platform to rotate when the electric motor is energized.

The attachment of the lift platform 3 to the trolley 4 is designed to incorporate a limited amount of flexibility to absorb road forces experienced by the system when in use transporting cargo on a vehicle. If the system were completely rigid, the cargo platform would experience high forces and could impact the vehicle, damaging either the vehicle or the lift system. Since the attachment incorporates some flexibility, the movement of the vehicle and the flexing of the tower and movement of the lift platform are absorbed by the attachment and do not cause damaging contact between the various components of the system. The drive system described above is designed to allow the flexibility necessary for the safe operation of the system, by flexing of the belt or chain. Similarly, the rotational attachment of the lift platform 3 to the trolley 4 allows movement that prevents damage from occurring during transport.

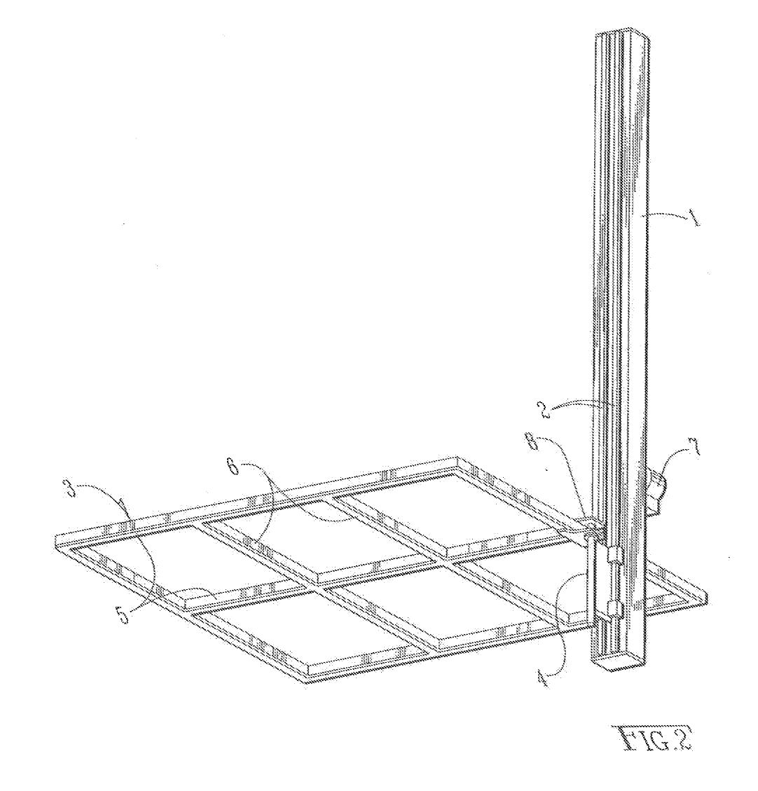

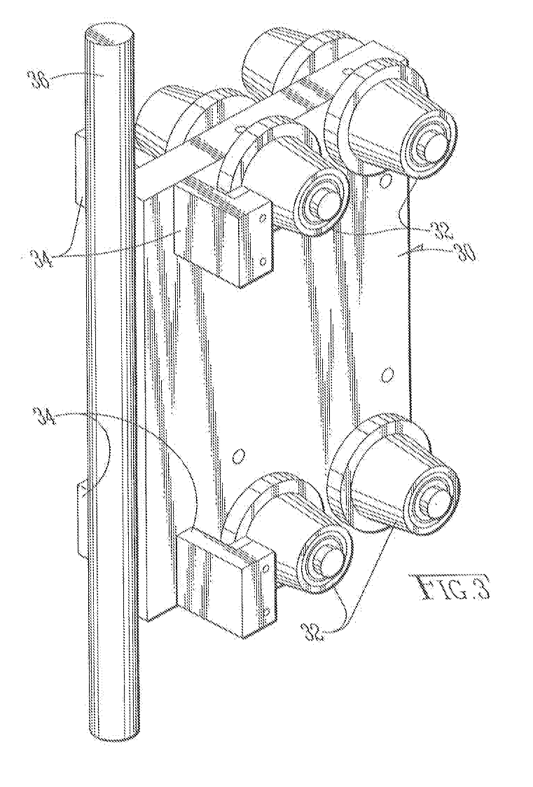

Referring now to FIG. 2, a perspective view of the cargo lift system in lowered position is depicted. As can be seen in this figure, the lift platform 3 has been rotated to the opposite side of the lift tower 1 when in the lowered position. The trolley 4 has translated to the lower end of the lift tower 1 by means of lift mechanism 7. Inside lift tower 1, trolley rail guides 2 are provided for slidably maintaining the trolley 4 in the lift tower. Rail guides 2 may comprise channels provided in the lift tower 1 to secure wheels, bearings or bushings on trolley 4, as more specifically described in relation to FIG. 3.

A lift mechanism 7 is provided in lift tower 1 to lift the trolley 4 from the lower end to the upper end of lift tower 1, and to lower it back again in a controlled manner and under a load from cargo on the lift platform. The lift mechanism is not limiting of this invention, and may be a manual or powered mechanism. The mechanism 7 may comprise a chain hoist, a screw translator, a cable and crank, hydraulic actuator, electric motor or translator, or any other suitable mechanism suitable for this purpose. The lift mechanism may be selected depending on the desired use and loading of the system.

Brackets 8 are provided on lift platform 3 to rotatably attach the lift platform 3 to the trolley 4. Other suitable means of attachment may be used in other embodiments of the lift system, and the specific brackets shown in the figure are not limiting of the invention.

Referring now to FIG. 3, a detailed perspective view of an embodiment of the trolley 4 and the swivel mechanism for the lift platform 3 is depicted. The trolley 4 may, in other embodiments, comprise other components. The trolley body 30 may be formed from metal, composite or other materials as suitable for the application and uses of the particular cargo lift system. Trolley guides 32 are attached to the trolley body 30 for engaging with the rail guides 2. Other components for stabilizing the body 30 with respect to rail guides 2 such as guides 34 may be provided depending on the design of the rail guides 2. The lift mechanism, not depicted in FIG. 3, attaches to body 30 for translating the trolley 4 up and down in the lift tower 1.

A swivel pin 36 is attached to the body 30 to carry the lift platform 3 and allow it to rotate around the lift tower 1. The lift platform 3 is provided with brackets to engage pin 36 and hold it on the trolley 4. Bushings, bearings or other means of rotatably securing the lift platform 3 on the trolley 4 may be utilized as necessary. In other embodiments of the trolley 4, other swivel supports may be used other than pin 36, such as multiple pins, brackets mounted on the trolley for receiving pins on lift platform 3, or matching brackets on the lift platform and trolley 4 mated by a bolt, may also be utilized, and the specific method of rotatably attaching the lift platform 3 to the trolley 4 is not limiting of the invention hereof.

When the lift tower 1 is attached to the vehicle, pin 36 is disposed so that when lift platform 3 is rotated in one direction it will be disposed away from the vehicle. When the lift platform is rotated 180 degrees away from the first position then the lift platform is disposed over the vehicle.

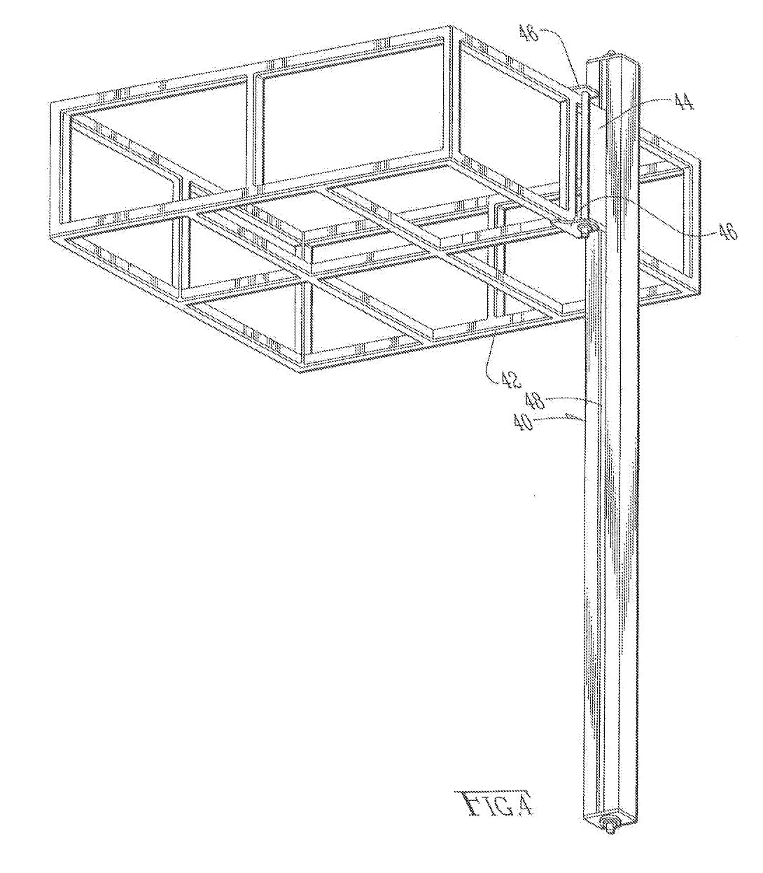

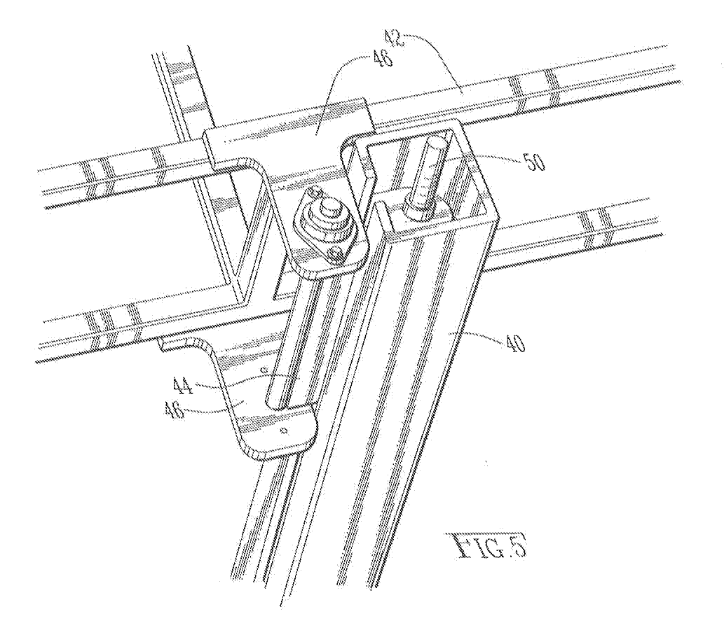

Referring now to FIGS. 4 and 5, a perspective view of an alternative embodiment of the cargo lift system and a detailed view of an alternative embodiment of the cargo lift system are depicted, respectively. The system has a lift tower 40, and a lift platform 42 with raised sides, mounted on trolley 44 by brackets 46. The slot 48 in the lift tower 40 allows the pin on trolley 44 to extend out from the lift tower 40 as the trolley 44 moves up and down.

The screw lift mechanism 50 can be see through the top of the lift tower which is not shown for clarity. Trolley 44 is attached to the lift mechanism 50 and is translated up and down the lift tower by the mechanism 50. Not shown in the figure is a swivel motor 52 to rotate the lift platform around the lift tower 40. The swivel motor 52 is typically mounted on the lift platform 42 and may comprise an electrical, pneumatic or hydraulic actuator. The actuator is connected to trolley 44 to rotate the platform around the trolley 44 and the lift tower 40. In one embodiment, the swivel motor 52 is connected to a sprocket or pulley mounted on the pin on trolley 44 by a chain or belt. Energizing the motor 52 causes the chain or belt to engage the sprocket or pulley thus rotating the platform 42.

In some embodiments of the cargo lift system, the system is provided with a control system for partially or fully automating control of the system during raising and lowering of the lift platform. The control system may incorporate position sensors that indicate when the trolley has moved to the top and bottom of the lift tower, when the trolley or lift platform is at an acceptable position for rotation towards or away from the vehicle, and the rotational position of the lift platform around the lift tower, though other position sensors or acceleration or velocity sensors may be utilized to control the system. The control system may allow the user to input simple commands such as “up” or “down” by means of an input device such as a control pad or switch box, and then through control circuits, either hard wired or programmed into a controller, safely raise or lower the lift platform.

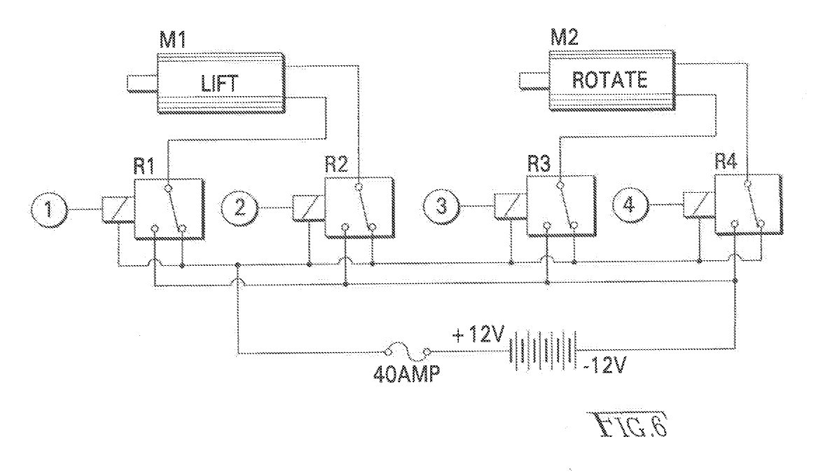

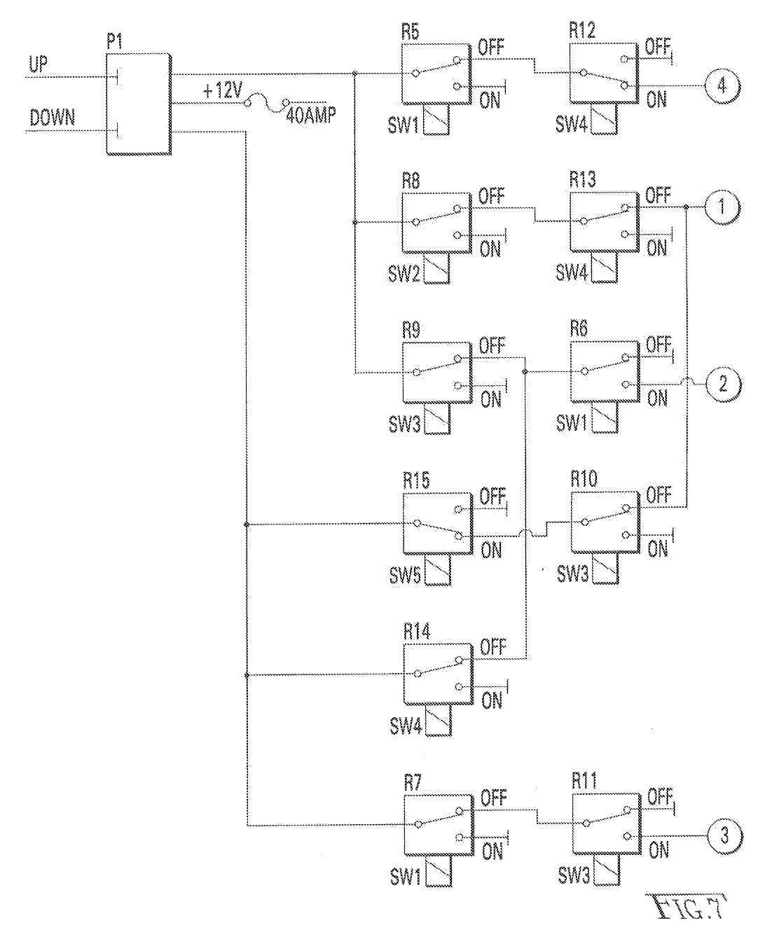

Referring now to FIGS. 6 and 7, partial schematic views of a control system for the cargo lift system are depicted. The embodiments depicted in the figures utilize switches disposed at various locations on the cargo lift system to identify the location of the lift platform and trolley, and to respond to commands from the user of the system. The switches allow the system to identify the location of the lift platform and trolley and to energize the lift and rotation motors at the appropriate times to raise and lower the lift platform. The switches SW1 are located near or at the top of the lift tower, switches SW2 are provided near the raised resting position of the lift platform, switch SW3 and SW4 indicate the rotate out and rotate in positions respectively, and the switch SW5 indicates the switch at or near the bottom of the lift tower. Motors M1 and M2 indicate the lift and rotation motors, respectively, and P1 indicates the panel by which a user inputs commands to raise or lower the lift platform. Points 1, 2, 3 and 4 indicate interconnection points between the schematics shown in FIGS. 6 and 7.

In other embodiments of the control system, a microcontroller is utilized to control the operation of the system and to accept input from a user. In other embodiments, optical or magnetic limit switches and position sensors are utilized to determine the position of the lift platform and trolley. Other control devices and position sensors may be used by one of skill to provide the necessary control system.

When the lift platform is rotated away from the vehicle it may be lowered to the ground level without impacting the vehicle. The user may load cargo on the lowered platform. In some cases cargo may even be rolled onto the platform using ramps or dollies. Once cargo has been loaded and secured to the lift platform, the lift mechanism is engaged to lift the lift platform to the top of the lift tower 1. Once at the top of the lift tower, the trolley is held in place and the swivel system is engaged to rotated the lift platform around the lift tower 1 until it is positioned over the vehicle. In some embodiments it may be desired to lower the lift platform until it is resting on a cargo platform, though in many embodiments the lift platform may be held above the vehicle loaded with the cargo while the vehicle is transported from place to place.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

What is claimed is:

1. A cargo lift system for a vehicle comprising a lift tower, a trolley slidably secured in the lift tower for translating from the top to the bottom of the lift tower, a lift platform rotatably attached to the trolley, and a lift mechanism disposed in the lift tower and capable of raising and lowering the trolley in the lift tower, wherein the lift platform may be rotated around the trolley from one side of the lift tower to the other.

2. The cargo lift system of claim 1 further comprising a swivel mechanism attached to the lift platform for rotating the lift platform around the lift tower.

3. The cargo lift system of claim 2 wherein the lift tower is attached to the side of a vehicle.

4. The method of transporting cargo on a vehicle comprising the steps of:
providing a cargo lift system comprising a lift tower, a trolley slidably disposed in the lift tower for translating from the top to the bottom thereof, a lift platform rotatably attached to the trolley, a lift mechanism disposed in the lift tower and capable of raising and lowering the trolley in the lift tower;
attaching the lift tower to the vehicle;
positioning the lift platform in a lowered position at or near a lower end of the lift tower and rotated away from the vehicle;
securing the cargo on the lift platform;
engaging the lift mechanism to raise the lift platform to at or near an upper end of the lift tower;
rotating the lift platform around the lift tower and above the vehicle.

5. The method of claim 4 wherein the step of providing a cargo system further comprises providing a swivel mechanism for rotating the lift platform around the lift tower.
